(19) United States
(12) Patent Application Publication
(10) Pub. No.: US 2009/0068533 A1
(43) Pub. Date: Mar. 12, 2009

(54) FUEL ELECTRODES FOR SOLID OXIDE ELECTROCHEMICAL CELL, PROCESSES FOR PRODUCING THE SAME, AND SOLID OXIDE ELECTROCHEMICAL CELLS

(75) Inventors: Takayuki Fukasawa, Tokyo (JP); Keizo Shimamura, Kawasaki-shi (JP); Yoshio Hanakata, Yokohama-shi (JP); Masato Yoshino, Yokohama-shi (JP); Kentaro Matsunaga, Tokyo (JP); Tsuneji Kameda, Tokyo (JP); Yoshiyasu Itoh, Yokohama-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/204,978

(22) Filed: Sep. 5, 2008

(30) Foreign Application Priority Data
Sep. 5, 2007 (JP) P2007-230748

(51) Int. Cl. H01M 8/10

(52) U.S. Cl. 429/33; 427/115

(57) ABSTRACT

A fuel electrode for a solid oxide electrochemical cell includes: an electrode layer including a mixed phase constituted of zirconia stabilized with yttrium oxide, ytterbium oxide, or scandium oxide and of an oxide selected from the group including an aluminum-based oxide and a magnesium-based composite oxide, said oxide having, supported on a surface part thereof, particles of at least one member selected from nickel, cobalt, and nickel-cobalt alloys; a meshy wiring formed on a surface layer part of the electrode layer and made of a material having higher electronic conductivity than the electrode layer; and a current collector which overlies the electrode layer and is in contact with at least the wiring.

### CROSS-REFERENCE TO RELATED APPLICATIONS

This application is based upon and claims the benefit of priority from the prior Japanese Patent Application No. 2007-230748, filed on Sep. 5, 2007, the entire contents of which are incorporated herein by reference.

### BACKGROUND OF THE INVENTION

1. Field

The present invention relates to solid oxide electrochemical cells such as, e.g., a solid oxide fuel cell (SOFC) and a solid oxide steam electrolysis cell (SOEC), fuel electrodes for use in the cells, and processes for producing the electrodes.

2. Description of the Related Art

A solid oxide fuel cell (SOFC) has an operating temperature as high as about 700° C.-1,000° C. and hence a high power generation efficiency, and is reduced in CO₂ generation. This fuel cell is hopeful as a next-generation clean power generation system.

With respect to fuel electrode materials for solid electrolyte fuel cells, a material constituted of ceramic particles whose surface has been covered with an electrically conductive metallic material and ceramic particles having oxygen ion conductivity has been proposed (see JP-A 5-174833).

A process for producing a fuel electrode for solid electrolyte fuel cells has also been proposed in which the electrode is produced, for example, by applying particles of a solid solution between NiO and MgAl₂O₄ to ZrO₂ and burning the resultant structure (see JP-A 7-105956). This process is intended mainly for regulating materials so as to have the same coefficient of thermal expansion and for heightening electronic conductivity. However, the amount of the ZrO₂ added is as small as about 10 vol %.

Furthermore, use of a system including NiAl₂O₄ and NiO in a fuel electrode (see JP-A 10-125333) and use of a system including nickel as a main component and further including NiAl₂O₄ in a fuel electrode (see JP-A 2003-242985) have been disclosed. In each technique, the NiAl₂O₄ is added for the purposes of regulating the electrode so as to have the same coefficient of thermal expansion as the YSZ (zirconia stabilized with yttrium oxide) to be used as a solid electrolyte and of inhibiting the particle growth and aggregation of nickel. These techniques employ a reduction temperature of about 900° C. Besides those, use of a nickel-magnesium oxide solid solution in a fuel electrode has been proposed (see JP-A 6-111829).

For reducing overvoltage and increasing catalytic activity in a fuel electrode, it is necessary to use finer metal particles as a catalyst and thereby increase the number of active sites. However, in a high-temperature reducing atmosphere, the metal particles are apt to readily move, grow, and aggregate. Furthermore, it is difficult to incorporate nickel particles in an unnecessarily large amount partly because of a difference in the coefficient of thermal expansion. In addition, in case where abrupt oxidation has occurred, the formation of an oxide results in volume expansion and leads to the risk of cell breakage.

### BRIEF SUMMARY OF THE INVENTION

According to the embodiments of the invention, examples of oxides having, supported on a surface part thereof, particles of at least one member selected from nickel, cobalt, and nickel-cobalt alloys include an aluminum-based oxide (a first aspect) and a magnesium-based composite oxide (a second aspect).

The invention may provide, according to a first aspect thereof, a fuel electrode comprising: an electrode layer comprising a mixed phase constituted of zirconia stabilized with yttrium oxide, ytterbium oxide, or scandium oxide and of an aluminum-based oxide having, supported on a surface part thereof, particles of at least one member selected from nickel, cobalt, and nickel-cobalt alloys; a meshy wiring formed on a surface layer part of the electrode layer and comprising a material having higher electronic conductivity than the electrode layer; and a current collector which overlies the electrode layer and is in contact with at least the wiring.

The invention may provide, according to a second aspect thereof, a fuel electrode comprising: an electrode layer constituted of a mixed phase composed of zirconia stabilized with yttrium oxide, ytterbium oxide, or scandium oxide and of a magnesium-based composite oxide having, supported on a surface part thereof, particles of at least one member selected from nickel, cobalt, and nickel-cobalt alloys; a meshy wiring formed on a surface layer part of the electrode layer and comprising a material having higher electronic conductivity than the electrode layer; and a current collector which overlies the electrode layer and is in contact with at least the wiring.

The invention may provide, according to a third aspect thereof, a solid oxide electrochemical cell including: a solid electrolyte plate having oxygen ion conductivity; the fuel electrode according to the first or second aspect of the invention disposed on one side of the solid electrolyte plate; and an air electrode disposed on the other side of the solid electrolyte plate, the air electrode comprising a composite oxide represented by Ln₁₋ₓAₓBO_{3-δ} (wherein Ln is a rare-earth element; A is Sr, Ca, or Ba; and B is at least one of Cr, Mn, Fe, Co, and Ni) or comprising a composite phase constituted of the composite oxide represented by Ln₁₋ₓAₓBO_{3-δ} and cerium oxides doped with at least one of samarium oxide, gadolinium oxide, and yttrium oxide.

The invention may provide, according to a fourth aspect thereof, a process for producing a fuel electrode which comprises: the steps of mixing zirconia stabilized with yttrium oxide, ytterbium oxide, or scandium oxide with a nickel-aluminum composite oxide, a cobalt-aluminum composite oxide, or a composite oxide composed of a nickel-aluminum composite oxide and a cobalt-aluminum composite oxide, superposing or forming a layer of the mixture on a surface of a solid electrolyte, and burning the mixture layer; and the step of reducing the resultant burned mixture at a temperature of from 800° C. to 1,000° C.

The invention may provide, according to a fifth aspect thereof, a process for producing a fuel electrode which comprises: the steps of mixing zirconia stabilized with yttrium oxide, ytterbium oxide, or scandium oxide with a nickel-magnesium composite oxide solid solution, a cobalt-magnesium composite oxide solid solution, or a composite oxide composed of a nickel-magnesium composite oxide and a cobalt-magnesium composite oxide solid solution, superposing or forming a layer of the mixture on a surface of a solid electrolyte, and burning the mixture layer; and the step of reducing the resultant burned mixture at a temperature of from 800° C. to 1,000° C.

According to embodiments of the invention, fuel electrodes having high catalytic activity and high durability can be provided, and solid oxide electrochemical cells which are stable and have excellent output performance can be realized. Furthermore, inexpensive production techniques such as screen printing and spray coating are applicable, whereby the electrodes can be produced at low cost.

### BRIEF DESCRIPTION OF THE DRAWINGS

FIG. 1 is a diagrammatic sectional view illustrating the structure of a solid oxide fuel cell (SOFC) according to a first embodiment of the invention.

FIG. 2 is a diagrammatic sectional view illustrating a three-phase interface in a fuel electrode according to the first embodiment.

FIG. 3 is a flowchart showing steps for producing the fuel electrode according to the first embodiment.

FIG. 4 is diagrammatic views illustrating sectional structures and a plan structure in steps for producing the fuel electrode according to the first embodiment.

FIG. 5 is a presentation showing a change in weight of NiAl₂O₄ during hydrogen reduction in an Example according to the first embodiment.

FIG. 6 is an SEM photograph of reduced NiAl₂O₄ in an Example according to the first embodiment.

FIG. 7 is a flowchart showing steps for producing the fuel electrode according to a second embodiment of the invention.

FIG. 8 is a presentation showing a change in weight of a nickel-magnesium composite oxide solid solution during hydrogen reduction in an Example according to the second embodiment.

FIG. 9 is an SEM photograph of a nickel-magnesium composite oxide solid solution in an Example according to the second embodiment.

### DETAILED DESCRIPTION OF THE INVENTION

The fuel electrodes for solid oxide fuel cells according to the embodiments of the invention and the processes of the embodiments of the invention for producing the electrodes are explained below. However, the invention should not be construed as being limited to the following embodiments and Examples. The diagrammatic views which are referred to in the following explanations are for illustrating the positional relationship between constituents, etc., and the size of the particles, the thickness ratio among the layers, etc. do not always coincide with actual ones.

### First Embodiment

A first embodiment of the invention relates to the fuel electrode according to the first aspect of the invention, the process for producing this fuel electrode, and the solid oxide fuel cell employing this fuel electrode.

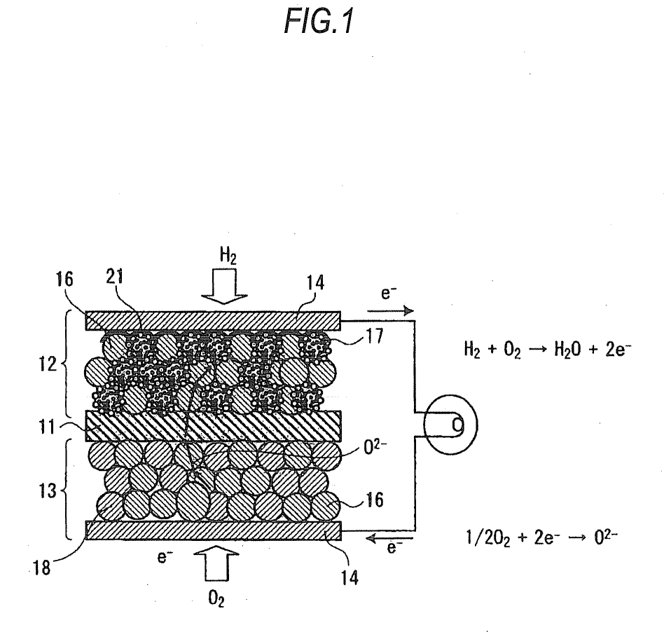

First, the solid oxide fuel cell according to this embodiment is explained by reference to the diagrammatic sectional view of FIG. 1. This solid oxide fuel cell has a multilayer structure composed of a solid electrolyte plate 11 having oxygen ion conductivity, a fuel electrode 12 disposed on one side of the plate 11, and an air electrode 13 disposed on the other side thereof.

The air electrode 13 includes composite oxide particles 18 which are particles of an oxide showing mixed electrical conductivity and represented by the general formula Ln₁₋ₓAₓBO_{3-δ} (wherein Ln is a rare-earth element; A is Sr, Ca, or Ba; and B is at least one of Cr, Mn, Fe, Co, and Ni). These composite oxide particles 18 efficiently dissociate oxygen and have electronic conductivity.

The composite oxide particles 18 represented by the general formula Ln₁₋ₓAₓBO_{3-δ} are slightly deficient in ionic conductivity. This deficiency may be compensated for by further adding ceria particles 20 having ionic conductivity. As the ceria particles, use is made of cerium oxide doped with samarium oxide, gadolinium oxide, or yttrium oxide. Such ceria particles are a material which shows mixed electrical conductivity in a reducing atmosphere but shows high ionic conductivity in an oxygen-containing atmosphere and which does not react with that oxide showing mixed electrical conductivity. The reason for the use of such ceria particles is that use of zirconia particles as an ionic conductor results in the possibility that the zirconia might form an insulating phase such as, e.g., LaZr₂O₇.

It is likewise thought that a reaction can take plate also at the interface between the air electrode 13, which contains the composite oxide 18 having mixed electrical conductivity, and the solid electrolyte plate 11. It is therefore preferred to form beforehand a thin and dense reaction-preventive layer at the interface between the solid electrolyte plate 11 and the air electrode 13 in order to inhibit the reaction. As a material for forming the reaction-preventive layer also, a ceria-based ion conductor is effective.

Oxygen ions (O²⁻) formed by dissociation in the air electrode 13 pass through the solid electrolyte 11 and move to the fuel electrode 12, where the oxygen ions react with hydrogen H₂ to yield water H₂O. Electrons e⁻ generate upon this reaction and are taken out through an external circuit to conduct power generation.

The dissociation of oxygen in the air electrode 13 and the reaction of hydrogen with oxygen ions on the fuel electrode 12 side each occur at those three-phase interfaces in the electrode where all of the catalyst (nickel or cobalt), oxygen ion conductor (YSZ), and feed gas (H₂) are present. Because of this, how to form such three-phase interfaces in a larger amount is an important subject.

In general fuel electrodes 12 heretofore in use, a cermet obtained by mixing nickel particles functioning as a catalyst and having electronic conductivity with particles of stabilized zirconia having oxygen ion conductivity (such as YSZ) and sintering the mixture has been employed. The nickel particles to be used for constituting this cermet are produced by reducing NiO and, hence, generally have a size of from several hundred nanometers to several micrometers, which is close to the size of the NiO particles used as a raw material. In the conventional technique, the nickel particles having such a size are connected to one another to constitute a network for electron conduction.

A measure which is thought to be effective in improving catalytic activity is to reduce the size of nickel particles to thereby increase the specific surface area. It is actually known that a fuel electrode produced using nickel particles having a reduced particle diameter obtained by a method in which nickel particles are precipitated from a solution of, e.g., a nitric acid salt or a method in which particles are mechanically pulverized as in the production of mechanical alloys shows high catalytic activity.

However, to reduce metal particles into finer particles results in a higher tendency to particle growth due to nickel particle sintering although it heightens activity. In addition, in a high-temperature reducing atmosphere, metal particles readily move. When the temperature is high, metal particles move to a surface layer part and an inner part of the electrode increases in resistance. For overcoming such a problem, it is necessary to reduce the particle diameter of the catalyst and simultaneously inhibit nickel movement/aggregation and thereby prevent internal resistance from increasing. Moreover, in case where nickel is added in an increased amount in order to heighten catalytic activity, this results in an increase in the coefficient of thermal expansion to form a cause of breakage of the cell itself. Because of this, the amount of nickel in terms of NiO amount is generally regarded as up to about 60% by weight at the most.

The present inventors diligently made investigations in order to eliminate those problems. As a result, it has been found that a technique in which a composite oxide solid solution (catalyst precursor) containing a metal functioning as an electrode catalyst is used to produce an electrode beforehand and then reduced to precipitate metal particles from the solid solution is effective in reducing the size of catalyst particles and fixing the particles to a base.

On the other hand, the nickel particles precipitated by the reduction of an aluminum-based composite oxide are fine but are discontinuously present on the insulator. There is hence a possibility that sufficient contact with a current collector member cannot be obtained. It has been found that to form beforehand a meshy wiring having electronic conductivity in a surface layer part of the electrode in order to compensate for a deficiency in electronic conductivity is effective in inhibiting the contact resistance of the fuel electrode from increasing due to current collection.

Namely, as shown in FIG. 1, the fuel electrode 12 according to the first embodiment includes: an electrode layer including a mixed phase constituted of zirconia 16 stabilized with, e.g., yttrium oxide and of an aluminum-based oxide 17 having, supported on a surface part thereof, particles of nickel, cobalt, a nickel-cobalt alloy, etc.; a meshy wiring 21 formed on a surface layer part of the electrode layer and made of a material having higher electronic conductivity than the electrode layer; and a current collector 14 which is in contact with the wiring 21.

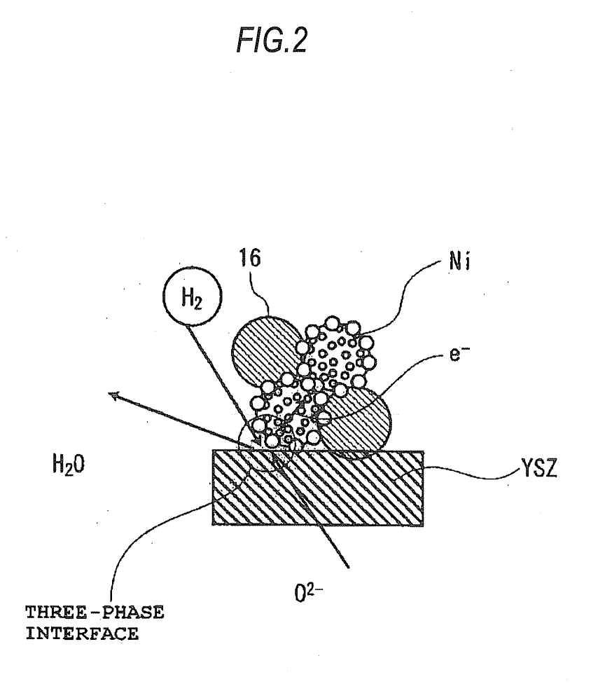

FIG. 2 is a diagrammatic sectional view of a three-phase interface in the fuel electrode 12. This figure diagrammatically illustrates a reaction occurring at an interface where the catalyst Ni, oxygen ion conductor YSZ (e.g., the electrolyte plate 11 or the oxide 16 having mixed electrical conductivity), and feed gas H₂ exist.

A process for producing this fuel electrode is explained below.

The process for fuel electrode production according to this embodiment is explained.

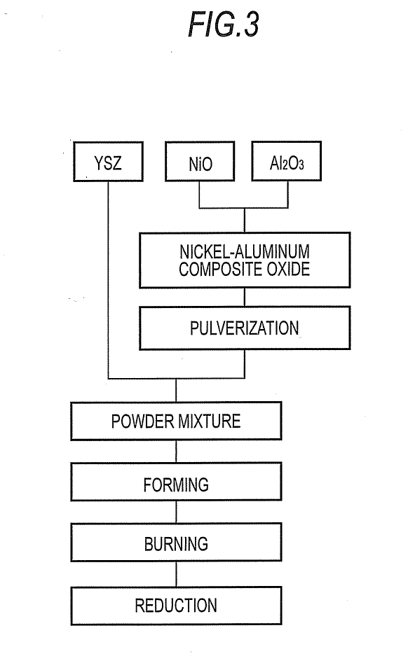

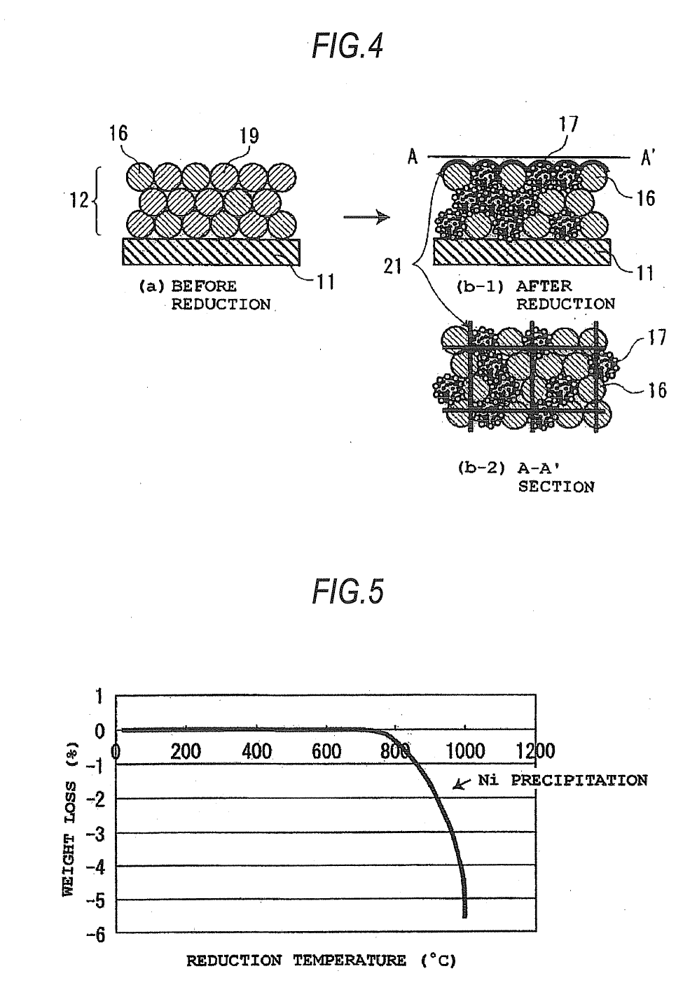

An example of production steps in this embodiment is shown in FIG. 3, and diagrammatic views of electrode structures are shown in FIG. 4.

First, an NiO powder is mixed with an Al₂O₃ powder, and the mixture is burned to produce a nickel-aluminum composite oxide solid solution represented by NiAl₂O₄. This solid solution is pulverized and used as particles 19. The powder thus obtained by pulverization has a particle diameter of preferably from 0.5 μm to 20 μm. For producing such a powder, use may be made of a method in which an aqueous solution of a metal salt such as, e.g., a nitrate, is used to mix the ingredients and the mixture is pyrolyzed and burned to produce the target powder.

The composite oxide solid-solution particles 19 thus produced are mixed with stabilized zirconia particles 16 having oxygen ion conductivity, and water is added thereto to obtain a paste. Examples of the stabilized zirconia particles to be used include zirconia particles stabilized with Y₂O₃, Yb₂O₃, or Sc₂O₃. However, the stabilized zirconia particles should not be construed as being limited to these, and any stabilized zirconia particles having high oxygen ion conductivity at temperatures of from 700° C. to 1,000° C. may be used. As the oxygen-ion-conductive particles 16 for constituting the electrode, it is preferred to use the same material as the solid electrolyte 11 from the standpoint of further improving bondability/conformability at the layer interface.

The powder mixture in a paste form is applied to a surface of a solid electrolyte plate 11 by screen printing, and the coating is burned by heating to a temperature which results in an elevated strength of bonding between the plate 11 and the coating. In general, it is preferred to burn the coating at a temperature in the range of from 1,200° C. to 1,400° C. Methods for disposing stabilized zirconia particles 16 and composite oxide solid-solution particles 19 on a solid electrolyte plate 11 should not be construed as being limited to the method described above. Use may be made of a method in which the powder mixture is slurried and this slurry is applied by roller coating, dipping, or spray coating to produce the target structure. Alternatively, the slurry may be formed into a sheet and then superposed.

From the standpoint of gas diffusibility in the electrode, it is preferred that the electrode layer should be porous. A pore-forming material which disappears upon burning to form pores may be incorporated beforehand. Examples of the pore-forming material include organic ones such as, e.g., acrylic spherical particles.

A processing for heightening the efficiency of current collection is further conducted. In a final material constitution, metal particles functioning as a catalyst and having electronic conductivity are in a finely dispersed state. It is therefore necessary to take a measure for securing sufficient contact with a current collector. In ordinary techniques, a material capable of serving as a current collector, such as a metal mesh, is pushed against the electrode to establish contact. In this embodiment, however, a meshy wiring 21 is formed on the electrode layer by printing with a material having higher electronic conductivity than the electrode part, and this meshy wiring 21 is brought into contact with a current collector to thereby secure current collection (see the diagrammatic sectional view of FIG. 4 (b-1) and the diagrammatic plan view of FIG. 4 (b-2)).

A line width of about 30 μm and a line-to-line distance of about 500 μm suffice for the wiring 21. This wiring 21 is formed so as to exert almost no influence on fuel diffusion. Although the line width, line-to-line distance, and wiring pattern are not particularly limited, it is preferred that the area occupied by the wiring part should account for up to 40% of the whole electrode surface.

As a material for forming the wiring through printing, a mixture of an electronic conductor such as Pt, Au, Ni, Co, or Fe and a stabilized zirconia material (YSZ material, YbSZ material, or ScSZ material) having oxygen ion conductivity for use in the electrode layer is used in the form of a paste. The terms YSZ material, YbSZ material, and ScSZ material mean zirconias stabilized with Y₂O₃, Yb₂O₃, and Sc₂O₃, respectively. The two ingredients are mixed preferably in such a ratio that the proportion of the metal part as an electronic conductor becomes 40-90 vol %. This is because not only such a mixing ratio improves tight contact and adhesion to the electrode layer but also the wiring itself can be expected to function as a catalyst.

The printed wiring part is burned. Thereafter, the fuel electrode is subjected to a reduction treatment in a reducing atmosphere having a temperature of from 800° C. to 1,000° C. Ordinary NiO reduction treatments are conducted at a temperature of about 900° C. without using an unnecessarily high temperature. However, in this embodiment, in which NiAl₂O₄ is used as a main component, it is more preferred to conduct the reduction at 950° C. or higher for the purpose of sufficiently precipitating nickel. Although the period of reduction is not particularly limited, about 10 minutes may suffice.

Through the reduction, the nickel ingredient present in the solid solution state in the NiAl₂O₄ part precipitates on the surface to give a base made of an aluminum oxide (mainly Al₂O₃). Namely, nickel-particle-supporting Al₂O₃ 17 is formed as shown in FIG. 4 (b-1) and (b-2). Although FIGS. 4 (a), (b-1), and (b-2) exaggeratingly illustrate the particulate state for easy understanding, the actual particles have been bonded together and united because of sintering and constitute a network. The fine metal particles thus formed have a size of generally tens of nanometers. From the standpoint of enabling the fine metal particles to have high catalytic activity, the size thereof is preferably from 5 nm to 200 nm. Metal particles having a size smaller than 5 nm are difficult to produce actually. Metal particles larger than 200 nm are apt to bond to adjoining ones and this may pose the same problem as in the conventional technique in which NiO is used after having been reduced. A more preferred range of the size of the fine metal particles as a catalyst is from 20 nm to 100 nm. This size is smaller than the conventional electrode catalyst sizes by one to two orders of magnitude. An improvement in catalytic activity is hence expected.

The amount of the NiAl₂O₄ to be added is preferably in the range of from 5% by weight to 50% by weight based on all materials constituting the electrode layer. More preferably, the amount thereof is from 10% by weight to 30% by weight. According to this embodiment, a reduction in catalyst amount can be attained and, hence, the proportion of the oxygen ion conductor can be increased. Consequently, the difference in thermal expansion between the electrode layer and the solid electrolyte and the difference due to conformation mismatch can be further reduced.

The fine metal particles precipitated are present on a surface part of the Al₂O₃ as a base so as to form only one layer. These particles have satisfactory conformability to the base and are tenaciously bonded thereto. Consequently, the fine metal particles are characterized in that even when exposed to a high-temperature reducing atmosphere, the particles do not readily move. In addition, since many of the metal particles are fine and isolated, this fuel electrode has an advantage that even when the electrode layer undergoes abrupt oxidation, the resultant volume expansion is only local and is less apt to lead to breakage.

As described above, in producing a fuel electrode according to this embodiment, fine nickel particles can be fixed to a base. In addition, according to this fuel electrode, high activity and long-term stability can be provided with a small nickel addition amount. When this fuel electrode is used in combination with an air electrode employing a preferable electrode catalyst, inexpensive high-output cells which may be not only a flat cell but also a cylindrical or electrode-supported cell or the like can be realized.

The nickel-particle-supporting Al₂O₃ produced by reducing NiAl₂O₄ is usable also as a catalyst for the reforming of hydrocarbon fuels including methane. Namely, it is applicable to a variety of fuels.

Examples according to the first embodiment are explained below. Electrodes employing Y₂O₃-stabilized ZrO₂ as oxygen-ion-conductive particles and electrodes employing Yb₂O₃- or Sc₂O₃-stabilized ZrO₂ as oxygen-ion-conductive particles all showed the same tendency. Consequently, in the following Examples, cells employing ZrO₂ stabilized with Y₂O₃ as an example are explained. The particle diameter and other properties of each of the powders used should not be construed as being limited to those shown below.

<Solid Electrolyte>

In all Examples, YSZ (ZrO₂ stabilized with 8 mol % Y₂O₃) processed so as to have a diameter of 15 mm and a thickness of 500 μm was used as a solid electrolyte. In all Examples, this solid electrolyte plate was used and a porous platinum electrode was used as an air electrode.

### Comparative Example 1

An NiO powder having an average particle diameter of about 1 μm and a YSZ powder (ZrO₂ stabilized with 8 mol % Y₂O₃) having an average particle diameter (D₅₀) of about 0.6 μm were weighed out in such amounts as to result in a weight ratio of 50:50. Pure water was added to the powders in an amount of about 50% based on the total weight thereof. The resultant mixture was treated with a high-speed rotary mixer to obtain a paste. Using a screen printer, the paste was printed in a size with a diameter of 6 mm on a central part of a YSZ solid electrolyte plate. After the printing, the solid electrolyte plate was placed in an atmospheric furnace and the paste was burned at 1,300° C. for 2 hours to obtain a fuel electrode. Thereafter, a platinum electrode likewise having a diameter of 6 mm was deposited on the opposite side by screen printing and burned at 950° C. for 1 hour to obtain an air electrode.

### Comparative Example 2

A nickel paste containing YSZ particles (in such an amount as to result in a YSZ/Ni ratio of 50:50 by weight) was produced. This nickel paste was applied to the fuel electrode of the sample produced in Comparative Example 1, by screen printing through a screen mesh produced so as to give a wiring having a line width of about 30 μm and a line-to-line distance of about 500 μm.

### Comparative Example 3

A sample was produced under the same conditions as in Comparative Example 1, except that the NiO powder and the YSZ powder were mixed in a ratio of 30:70 by weight. The same meshy wiring as that shown in Comparative Example 2 was formed by printing on a surface layer part of the fuel electrode produced.

### Examples 1 to 3

An NiO powder having an average particle diameter of about 1 μm and an Al₂O₃ powder having an average particle diameter of about 0.4 μm were weighed out in such amounts as to result in a molar ratio of 1:1. The powders were mixed together by means of a mortar. The resultant powder mixture was press-molded, and the molding was sintered at 1,300° C. of 5 hours in the air. The constituent phases of the sinter obtained were examined by X-ray diffractometry.

Subsequently, the sinter was pulverized and passed through a 40-μm mesh sieve to obtain a starting powder (nickel-aluminum composite oxide). The pulverized composite oxide particles were mixed with YSZ (ZrO₂ stabilized with 8 mol % Y₂O₃) particles having an average particle diameter of 0.6 μm in each of such ratios as to result in pulverized-particle proportions of 10, 20, and 50% by weight. Thus, respective powder mixtures were prepared (Examples 1 to 3).

To each of the powder mixtures was added about 40% by weight pure water. The resultant mixtures each were treated with a high-speed rotary mixer to obtain pastes. Using a screen printer, each paste was printed in a size with a diameter of 6 mm on a central part of a YSZ solid electrolyte plate. After the printing, the solid electrolyte plates were placed in an atmospheric furnace and the pastes were burned at 1,300° C. for 2 hours to obtain fuel electrodes. Subsequently, a platinum electrode was likewise deposited by printing on the opposite side of each solid electrolyte plate and burned at 950° C. for 1 hour to obtain an air electrode. The same meshy wiring as that shown in Comparative Example 2 was formed by printing on a surface layer part of each fuel electrode produced.

### Comparative Example 4

The same structure as that produced in Example 2 was produced, except that the meshy wiring on the surface part was omitted. Thus, the structure of Comparative Example 4 was prepared.

### Example 4

A CoO powder having an average particle diameter of about 1 μm and an Al₂O₃ powder having an average particle diameter of about 0.4 μm were weighed out in such amounts as to result in a molar ratio of 1:1. The powders were mixed together by means of a mortar. The resultant powder mixture was press-molded, and the molding was sintered at 1,300° C. of 5 hours in the air. The constituent phases of the sinter obtained were examined by X-ray diffractometry.

Subsequently, the sinter was pulverized and passed through a 40-μm mesh sieve to obtain a starting powder (cobalt-aluminum composite oxide). The pulverized composite oxide particles were mixed with YSZ (ZrO₂ stabilized with 8 mol % Y₂O₃) particles having an average particle diameter of 0.6 μm in such a ratio as to result in a pulverized-particle proportion of 20% by weight. Thus, a powder mixture was prepared. To the powder mixture was added about 40% by weight pure water. The resultant mixture was treated with a high-speed rotary mixer to obtain a paste.

Using a screen printer, the paste was printed in a size with a diameter of 6 mm on a central part of a YSZ solid electrolyte plate. After the printing, the solid electrolyte plate was placed in an atmospheric furnace and the paste was burned at 1,300° C. for 2 hours. Subsequently, a platinum electrode was likewise deposited by printing on the opposite side of the solid electrolyte plate and burned at 950° C. for 1 hour to obtain an air electrode. The same meshy wiring as that shown in Comparative Example 2 was formed by printing on a surface layer part of the fuel electrode produced.

### Examples 5 and 6

Samples were produced in the same manner as in Examples 1 to 3, except that the proportions of the nickel-aluminum composite oxide particles were changed to 8 or 55% by weight (Examples 5 and 6, respectively). The same meshy wiring as that shown in Comparative Example 2 was formed by printing on a surface layer part of each fuel electrode produced.

<Cell Characteristics Evaluation Test>

Each flat cell produced was set on an SOFC output characteristics evaluation apparatus, and the fuel electrode side and the air electrode side each were sealed with a Pyrex® glass material. A platinum wire having a diameter of 0.1 mm was attached as a reference electrode to a side of the electrolyte plate. The cell was heated in an argon atmosphere. Thereafter, hydrogen was introduced into the fuel electrode to conduct a reduction treatment. In Comparative Examples 1 to 3, the treatment was conducted at 900° C. for 1 hour. In Examples 1 to 6 and Comparative Example 4, the treatment was conducted at 1,000° C. for 10 minutes.

Subsequently, H₂+H₂O were introduced into the fuel electrode at 50 cc/min, and dry air+argon were introduced into the air electrode at 50 cc/min (dry air, 10 cc/min; argon, 40 cc/min). Thus, the cell was evaluated for output characteristics. Furthermore, an impedance measurement was made by the current interruption method.

An explanation is made on the results. The thickness of each electrode layer formed through one screen printing operation was about 20 μm. The results of the X-ray diffraction test revealed that in Comparative Examples 1 to 3, the components of the fuel electrode after the reduction were nickel and YSZ. In contrast, in Examples 1 to 3, 5, and 6 and Comparative Example 4, peaks attributable to YSZ and NiAl₂O₄ were detected in the composition before the reduction, and peaks attributable to YSZ, nickel, and Al₂O₃ were detected in the composition after the reduction. In Example 4, peaks attributable to YSZ, cobalt, and Al₂O₃ were detected after the reduction.

The NiAl₂O₄ was examined with a thermo-gravimetric analyzer (TG) for weight change with reduction in hydrogen. The results obtained are shown in FIG. 5. Weight decrease, i.e., nickel precipitation, began at around 800° C., and a weight loss of about 6% was observed at 1,000° C. These results suggest that the fuel electrodes produced through reduction at 1,000° C. can be used more stably because the electrodes include metal particles precipitated at high temperatures and are used at lower temperatures.

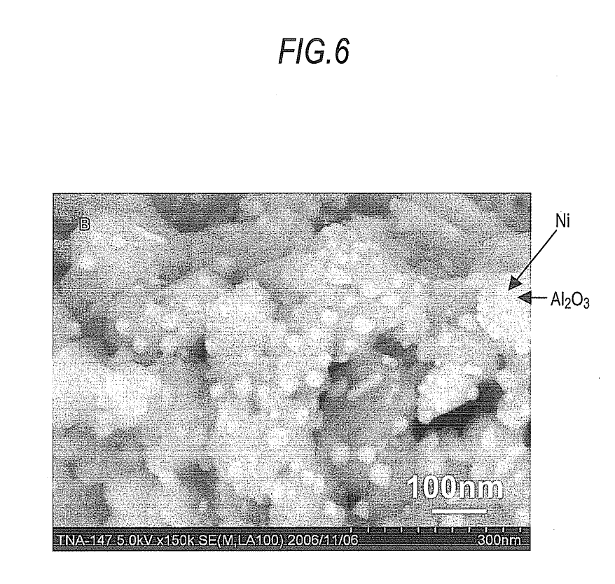

A structure examination was further made with an SEM. As a result, it was ascertained that in Comparative Example 1, for which NiO had been used, nickel particles having a size of about 1 μm were present among YSZ particles. In contrast, in each of the systems for which NiAl₂O₄ had been used, the presence of YSZ particles and Al₂O₃ particles having nickel particles of a size of from tens of nanometers to about 100 nm precipitated on the surface thereof was ascertained (see FIG. 6). The nickel particles precipitated are highly dispersed on the Al₂O₃ without overlapping.

In Table 1 are shown the results concerning maximum output density obtained by I-V characteristics evaluation. In the table, the catalyst precursor amount means the proportion of NiO or NiAl₂O₄.

TABLE 1

| | Constituent | Constituent | Catalyst | | Output |
|---|---|---|---|---|---|
| | phases before | phases after | precursor amount | Meshy | density |
| | reduction | reduction | (wt %) | wiring | (mW/cm²) |
| Example 1 | NiAl₂O₄-YSZ | Ni/Al₂O₃-YSZ | 10 | present | 92 |
| Example 2 | NiAl₂O₄-YSZ | Ni/Al₂O₃-YSZ | 20 | present | 82 |
| Example 3 | NiAl₂O₄-YSZ | Ni/Al₂O₃-YSZ | 40 | present | 67 |
| Example 4 | CoAl₂O₄-YSZ | Co/Al₂O₃-YSZ | 20 | present | 75 |
| Comparative | NiO-YSZ | Ni-YSZ | 50 | absent | 89 |
| Example 1 | | | | | |
| Comparative | NiO-YSZ | Ni-YSZ | 50 | present | 90 |
| Example 2 | | | | | |
| Comparative | NiO-YSZ | Ni-YSZ | 30 | present | 59 |
| Example 3 | | | | | |
| Comparative | NiAl₂O₄-YSZ | Ni/Al₂O₃-YSZ | 20 | absent | 25 |
| Example 4 | | | | | |
| Example 5 | NiAl₂O₄-YSZ | Ni/Al₂O₃-YSZ | 3 | present | 21 |
| Example 6 | NiAl₂O₄-YSZ | Ni/Al₂O₃-YSZ | 60 | present | 38 |
| Example 7 | (Ni, Mg) O-YSZ | Ni/(Ni, Mg) O-YSZ | 10 | present | 88 |
| Example 8 | (Ni, Mg) O-YSZ | Ni/(Ni, Mg) O-YSZ | 20 | present | 84 |
| Example 9 | (Ni, Mg) O-YSZ | Ni/(Ni, Mg) O-YSZ | 40 | present | 69 |
| Example 10 | (Co, Mg) O-YSZ | Co/(Co, Mg) O-YSZ | 20 | present | 70 |
| Comparative | (Ni, Mg) O-YSZ | Ni/(Ni ,Mg) O-YSZ | 20 | absent | 22 |
| Example 5 | | | | | |
| Example 11 | (Ni, Mg) O-YSZ | Ni/(Ni, Mg) O-YSZ | 3 | present | 26 |
| Example 12 | (Ni, Mg) O-YSZ | Ni/(Ni ,Mg) O-YSZ | 60 | present | 32 |

As apparent from the table, in the case of the NiO-YSZ systems, which are conventional materials, output characteristics tended to decrease with decreasing nickel amount. This may be because a decrease in nickel amount results in difficulties in forming electron-conducting paths. In contrast, in the case of the materials according to the Examples, output characteristics tended to improve even with small nickel amounts. This is thought to be mainly because the amount of Al₂O₃, which is an insulator, decreased and this resulted in reduced internal resistance of the electrode and also in an increased amount of YSZ paths, which conduct oxygen ions. Conversely speaking, the electrodes have sufficiently high catalytic activity even with small nickel amounts.

It was further found that the formation of a meshy wiring on a surface layer part by printing was highly effective in the YSZ-NiAl₂O₄ systems although it exerted almost no influence in the conventional YSZ-NiO systems. Namely, in the techniques according to the Examples, in which NiAl₂O₄ is used, contact with the current collector for current collection is important although catalytic activity improves with reducing catalyst size. It has become obvious that the formation of a meshy wiring on a surface layer part by printing is highly effective in reducing the loss to be caused by current collection contact resistance.

It can be seen from those results that output characteristics equal to or higher than those of conventional materials can be imparted with smaller catalyst amounts according to the Examples. This is thought to be mainly caused by an increased amount of three-phase interfaces due to the catalyst particle size reduction and the resultant increase in catalytic activity.

In the YSZ-NiO materials shown in Comparative Examples 1 to 3, the nickel particles in the materials before a power generation test had a size of about 1 μm. However, after a 300-hour power generation test at 900° C., a decrease in output density of about 25% was observed. In the structure of each of these materials which had undergone the test, it was observed that the nickel particles had grown (sintered) into particles larger than a two-fold size.

In contrast, the electrode catalysts of the Examples according to the first embodiment had not undergone the uniting of nickel particles although slight particle growth was observed. No decrease in output density was also observed. Namely, the results obtained show that the catalysts are more effective also from the standpoint of durability. This is attributable to the fact that these catalysts were synthesized at a higher temperature than the conventional NiO-based materials, and means that the catalysts according to the first embodiment have excellent thermal stability.

Also in the case of using a cobalt-aluminum composite oxide as a precursor, cobalt particle precipitation occurred and the same electrode catalyst effects were ascertained.

Furthermore, cells employing the fuel electrodes according to this embodiment in combination with various air electrodes were found to show satisfactory output performance. As an air-electrode material, use can be made of, for example, one represented by the general formula Ln₁₋ₓAₓBO_{3-δ} (wherein Ln is a rare-earth element; A is Sr, Ca, or Ba; and B is at least one of Cr, Mn, Fe, Co, and Ni), such as (La, Sr) (Co, Fe)O₃. At least one member selected from SDC materials, GDC materials, and YDC materials may be added to the Ln₁₋ₓAₓBO_{3-δ} in order to enhance ionic conductivity. A fuel cell system produced from one or more cells employing such a combination was ascertained to have excellent durability and show high-performance power-generating properties. Such cells can be extensively applied not only to the flat type but also to the known cylindrical type and fuel-electrode-supported type.

The aluminum-based composite oxide solid solution which comes to support fine metal particles, which was used in the embodiment described above, is useful also as a catalyst for the reforming of hydrocarbon fuels including methane. This solid solution is hence expected to be applied to techniques concerning SOFCs of the internal reforming type.

### Second Embodiment

A second embodiment of the invention relates to the fuel electrode according to the second aspect of the invention and the process for producing this fuel electrode. The fuel electrode which will be explained below can be applied to the solid oxide fuel cell explained by reference to FIG. 1.

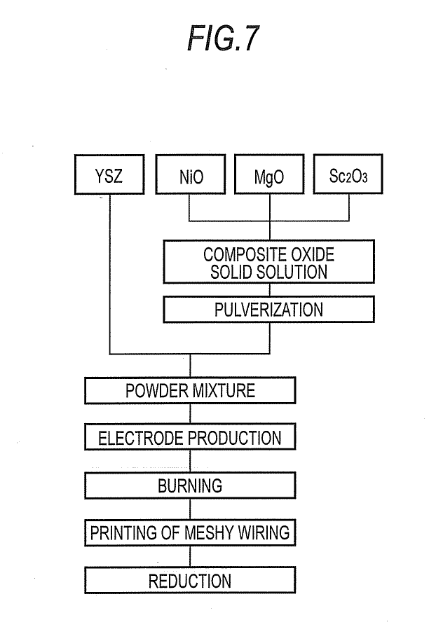

An example of production steps for use in this embodiment is shown in FIG. 7. In this example, nickel is used as a catalyst.

First, an NiO powder, an MgO powder, and a slight amount of an Sc₂O₃ powder are mixed together, and the mixture is burned to produce an MgO—NiO solid solution. Because the Sc₂O₃ amount is slight, the Sc³⁺ ions are finally incorporated in the solid solution. When this nickel-magnesium composite oxide solid solution is reduced at 800-1,000° C., more preferably at a temperature of from 900° C. to 1,000° C., nickel particles having a size of tens of nanometers precipitate on the surface. Thus, the solid solution becomes a composite, i.e., a magnesium-based composite oxide having fine nickel particles supported thereon.

Other examples of such systems which form a solid solution with magnesium oxide and from which fine metal particles effective as an electrode catalyst precipitate upon reduction include a CoO—MgO solid solution system. In this system also, the precipitation of metal particles can be accelerated with a slight amount of an additive element. Examples of such substances having the effect of accelerating the precipitation include Al₂O₃ and Cr₂O₃ besides Sc₂O₃.

An amount of about from 0.01% by mole to 1.0% by mole based on the magnesium-based composite oxide solid solution as a base suffices for those additive ingredients. By adding such an additive ingredient in such a slight amount, the amount of particles to be precipitated and the specific surface area of the metal can be improved by about one order of magnitude as compared with the case in which the minor ingredient is not added at all.

This sinter is pulverized into particles. The powder obtained by pulverization has a particle diameter of preferably from 0.5 μm to 20 μm. For producing such a powder, use may be made of a method in which an aqueous solution of a metal salt such as, e.g., a nitrate, is used to mix the ingredients and the mixture is pyrolyzed and burned to produce the target powder.

The magnesium-based composite oxide solid-solution particles are mixed with oxygen ion conductive particles, and water is added thereto to obtain a paste. As the oxygen ion conductor, use is made of YSZ (Y₂O₃-doped ZrO₂), YbSZ (Yb₂O₃-doped ZrO₂), or ScSZ (Sc₂O₃-doped ZrO₂). The paste is applied to a solid electrolyte 11 by screen printing, and the coating is burned by heating to a temperature which results in an elevated strength of bonding between the electrolyte 11 and the coating. In general, it is preferred to burn the coating at a temperature in the range of from 1,200° C. to 1,400° C. Methods for electrode formation should not be construed at being limited to the printing method. Use may be made of a method in which the powder mixture is slurried and this slurry is applied by roller coating or spray coating to produce the electrode. Alternatively, the slurry may be formed into a sheet and then superposed. A section of the structure in this state is the same as that shown in FIG. 4 (a), wherein YSZ particles are designated by 16 and the magnesium-based composite oxide is designated by 19.

In FIG. 4, particles are exaggeratingly illustrated for easy understanding. However, the actual particles have been bonded together and united because of sintering and constitute a network. From the standpoint of gas diffusibility in the electrode, it is preferred that the electrode layer should be porous. A pore-forming material which disappears upon burning to form pores may be incorporated beforehand. Examples of the pore-forming material include organic ones such as, e.g., acrylic spherical particles.

Generally used as the solid electrolyte 11 is dense ZrO₂ stabilized with Y₂O₃, Yb₂O₃, Sc₂O₃, or the like. However, the solid electrolyte 11 should not be construed as being limited to that, and any solid electrolyte having high oxygen ion conductivity at temperatures of from 700° C. to 1,000° C. may be used.

A processing for heightening the efficiency of current collection is further conducted. In a final material constitution to be obtained by the process according to this embodiment, metal particles functioning as a catalyst and having electronic conductivity are fine particles which are isolated and dispersed. It is therefore necessary to take a measure for securing sufficient contact with a current collector. In ordinary techniques, a material capable of serving as a current collector, such as a metal mesh, is pushed against the electrode to establish contact. In this embodiment, however, a meshy wiring 21 is formed on the electrode layer by printing with a material having higher electronic conductivity than the electrode part (FIG. 4 (b-1) and (b-2)), and this meshy wiring 21 is brought into contact with a current collector to thereby secure current collection. A line width of about 30 μm and a line-to-line distance of about 500 μm suffice for the wiring formed by printing. This wiring 21 exerts almost no influence on fuel diffusion. Although the line width, line-to-line distance, and wiring pattern are not limited to those, it is preferred that the area occupied by the wiring part should account for up to 40% of the whole electrode surface. As a material for forming the wiring through printing, a mixture of Pt, Au, Ni, Co, Fe, or the like and YSZ, YbSZ, or ScSZ, which is a material having oxygen ion conductivity for use in the electrode layer, is used. The two ingredients are mixed preferably in such a ratio that the proportion of the metal material becomes 40-90 vol %. This is because not only such a mixing ratio improves tight contact and adhesion to the electrode layer but also the wiring itself can be expected to function as a catalyst.

The printed wiring part is burned. Thereafter, the resultant structure is subjected to a reduction treatment at a temperature of from 800° C. to 1,000° C. in, e.g., a hydrogen atmosphere. Ordinary reduction treatments for fuel electrode production using NiO as a starting material are conducted at about 900° C. without using an unnecessarily high temperature because of the possibility of aggregation, etc. However, in the case of using, e.g., the nickel-magnesium composite oxide solid solution according to this embodiment, it is preferred to conduct the reduction at 900° C. or higher in order to sufficiently precipitate nickel. More preferably, the reduction is conducted at a temperature of from 950° C. to 1,000° C. Although the period of reduction is not particularly limited, about 10 minutes may suffice. Through the reduction, the metal ingredient present in the solid solution state in the magnesium composite oxide solid solution precipitates on the surface to give a base made of a magnesium-rich composite oxide.

Namely, a magnesium-based composite oxide 17 having fine metal particles supported thereon is formed (see FIG. 4 (b-1) and (b-2)). Although FIG. 4 (b-1) and (b-2) illustrate the composite oxide as individual particles for the purpose of image exaggeration, the actual particles are thought to have been bonded to one another because of sintering to thereby form a network structure.

The metal particles formed by the method described above have a size of about tens of nanometers. From the standpoint of enabling the metal particles to have high catalytic activity, the size of the precipitated metal particles is preferably regulated to from 5 nm to 200 nm. The reasons for this are as follows. Metal particles having a size smaller than 5 nm are difficult to produce actually. Metal particles larger than 200 nm cannot be expected to produce high catalytic activity as compared with ones obtained by, e.g., the conventional reduction of NiO particles. A more preferred range of the size of the metal particles as an actual catalyst is about from 20 nm to 100 nm. This size is smaller than the conventional electrode catalyst sizes by one to two orders of magnitude.

The amount of the magnesium-based composite oxide solid solution to be added in electrode production is preferably in the range of from 5% by weight to 50% by weight. More preferably, the amount thereof is from 10% by weight to 30% by weight. In the process according to this embodiment, magnesium-based particles having insulating properties remain even after the reduction treatment and, hence, it is undesirable to add this part in a large amount. Because activity is improved by reducing catalyst size, the amount of the composite oxide solid solution to be added can be reduced accordingly. As a result, the proportion of the material having mixed electrical conductivity, which is more akin in properties (e.g., the coefficient of thermal expansion) to the solid electrolyte as a base, increases and the difference due to mismatch can be further reduced.

The fine metal particles precipitated are present on a surface part of the magnesium-based composite oxide as a base so as to form only one layer. These particles have satisfactory conformability to the base and are tenaciously bonded thereto. Consequently, the fine metal particles are characterized in that even when exposed to a high-temperature reducing atmosphere, the particles do not readily move.

In addition, since the metal particles present are fine and isolated, this fuel electrode has an advantage that even when the electrode layer undergoes abrupt oxidation, the resultant volume expansion is only local and is less apt to lead to breakage.

In JP-A 6-111829, a solid solution having a magnesium oxide content regulated to 5-25% by mole is used, i.e., a nickel-rich region is employed. This is intended to take account of electronic conductivity. Because of such conditions, the amount of nickel to be precipitated changes considerably with changing reduction temperature and the nickel particles are apt to aggregate/unite with one another. In this respect, in the process according to this embodiment, nickel particles retaining a small particle diameter can be precipitated on the surface of the NiO—MgO solid solution without fail, although the amount of the nickel is small. The fuel electrode thus produced is less apt to decrease in catalytic performance even when used over long.

As described above, in producing a fuel electrode according to this embodiment, fine nickel particles can be fixed to a base. In addition, according to this fuel electrode, high activity and long-term stability can be obtained with a small nickel addition amount. When this fuel electrode is used in combination with an air electrode employing a preferable electrode catalyst, inexpensive high-output cells which may be not only a flat cell but also a cylindrical or electrode-supported cell or the like can be realized.

The nickel-particle-supporting (Ni, Mg)O produced by reducing NiO—MgO is usable also as a catalyst for the reforming of hydrocarbon fuels including methane. Namely, it is applicable to a variety of fuels.

The second embodiment is explained below in more detail by reference to the following Examples. Electrodes employing Y₂O₃-stabilized ZrO₂ as oxygen-ion-conductive particles and electrodes employing Yb₂O₃— or SC₂O₃-stabilized ZrO₂ as oxygen-ion-conductive particles all showed the same tendency. Consequently, in the following Examples, cells employing ZrO₂ stabilized with Y₂O₃ as an example are explained. Likewise, the particle diameter and other properties of each of the powders used should not be construed as being limited to those shown below.

<Solid Electrolyte>

In all tests, YSZ (ZrO₂ stabilized with 8 mol % Y₂₀₃) processed so as to have a diameter of 15 mm and a thickness of 500 μm was used as a solid electrolyte.

In all of the Examples and Comparative Example, this solid electrolyte plate was used and a porous platinum electrode was used as an air electrode.

### Examples 7 to 9

An NiO powder having an average particle diameter of about 1 μm, an MgO powder having an average particle diameter of about 1 μm, and an Sc₂O₃ powder were weighed out in such amounts as to result in a molar ratio of 1:2:0.2. The powders were mixed together by means of a mortar. The resultant powder mixture was press-molded, and the molding was sintered at 1,300° C. of 5 hours in the air. The constituent phases of the sinter obtained were examined by X-ray diffractometry. Subsequently, the sinter was pulverized and passed through a 40-μm mesh sieve to obtain a starting powder (nickel-magnesium composite oxide solid solution). The pulverized composite oxide solid-solution particles were mixed with YSZ (ZrO₂ stabilized with 8 mol % Y₂O₃) particles having an average particle diameter of 0.6 μm in each of such ratios as to result in pulverized-particle proportions of 10, 20, and 40% by weight. Thus, respective powder mixtures were prepared (Examples 7 to 9).

To each of the powder mixtures was added about 40% by weight pure water. The resultant mixtures each were treated with a high-speed rotary mixer to obtain pastes. Using a screen printer, each paste was printed in a size with a diameter of 6 mm on a central part of a YSZ solid electrolyte plate. After the printing, the solid electrolyte plates were placed in an atmospheric furnace and the pastes were burned at 1,300° C. for 2 hours. Subsequently, a platinum electrode was likewise deposited by printing on the opposite side of each solid electrolyte plate and burned at 960° C. for 1 hour to obtain an air electrode. The same meshy wiring as that shown in Comparative Example 2 was formed by printing on a surface layer part of each fuel electrode produced.

### Comparative Example 5

The same structure as that produced in Example 8 was produced, except that the meshy wiring on the surface part was omitted. Thus, the structure of Comparative Example 5 was prepared.

### Example 10

MgO was mixed with CoO and with Sc₂O₃ as an additive for accelerating cobalt precipitation, in a molar ratio of 1:2:0.2. The resultant mixture was burned at 1,300° C. to obtain a cobalt-magnesium composite oxide solid solution. This solid solution was pulverized to produce a fuel electrode in the same manner as in Example 5, and a mesh wiring was formed by printing on a surface part of the electrode in the same manner.

### Examples 11 and 12

Samples were produced in the same manner as in Examples 5 to 7, except that the proportions of the nickel-magnesium composite oxide solid solution were changed to 8 or 55% by weight (Examples 11 and 12, respectively). The same meshy wiring as that shown in Comparative Example 2 was formed by printing on a surface layer of each fuel electrode produced.

<Cell Characteristics Evaluation Test>

Each flat cell produced was set on an SOFC output characteristics evaluation apparatus, and the fuel electrode side and the air electrode side each were sealed with a Pyrex® glass material. A platinum wire having a diameter of 0.1 mm was attached as a reference electrode to a side of the electrolyte plate. The cell was heated in an argon atmosphere. Thereafter, hydrogen was introduced into the fuel electrode to conduct a reduction treatment. The reduction was conducted at 1,000° C. for 10 minutes.

Subsequently, H₂+H₂O were introduced into the fuel electrode at 50 cc/min, and dry air+argon were introduced into the air electrode at 50 cc/min (dry air, 10 cc/min; argon, 40 cc/min). Thus, the cell was evaluated for output characteristics. Furthermore, an impedance measurement was made by the current interruption method.

An explanation is made on the results. The thickness of each electrode layer formed through one screen printing operation was about 20 μm. The results of the X-ray diffraction test are as follows. In Examples 7 to 12 and Comparative Example 5, peaks attributable to YSZ and an (Ni, Mg)O-based solid solution were detected in the composition before the reduction, and peaks attributable to YSZ, nickel, and an (Ni, Mg)O-based solid solution were detected in the composition after the reduction.

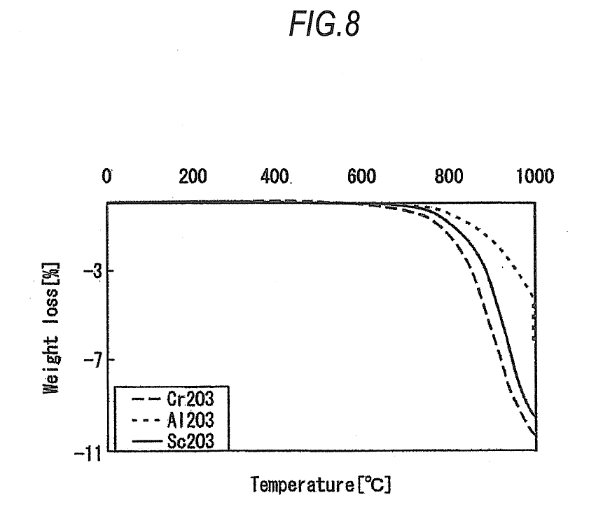

The nickel-magnesium composite oxide solid solution was examined with a thermo-gravimetric analyzer (TG) for weight change with reduction in hydrogen. The results obtained are shown in FIG. 8. The addition of each of Sc₂O₃, Cr₂O₃, and Al₂O₃ in a slight amount brought about a large weight loss. The MgO—NiO composite oxide solid solution to which none of these additives had been added had a reduction loss at 1,000° C. of about 0.5%. It can hence be seen that the addition of the additives accelerated the reduction (nickel precipitation). Reduction at 1,000° C. means that the fuel electrodes produced can be used more stably because the electrodes include metal particles precipitated at high temperatures and are used at lower temperatures.

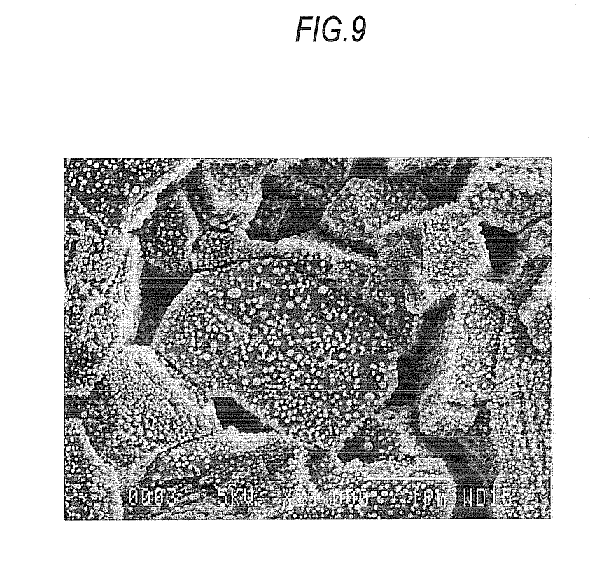

A structure examination was further made with an SEM. As a result, it was ascertained that in Comparative Example 1, for which NiO had been used, nickel particles having a size of about 1 μm were present among YSZ particles. In contrast, in each of the systems for which NiO—MgO had been used, nickel particles of a size of from tens of nanometers to about 100 nm precipitated on the surface of the magnesium-based composite oxide particles were ascertained (see FIG. 9). Although this figure shows an example for which Sc₂O₃ had been used, the case of adding Cr₂O₃ or Al₂O₃ gave the same structure. A measurement of specific surface area revealed that the nickel particles had been precipitated in an amount about 10 times the nickel particle amount in the material obtained by reducing an NiO—MgO composite oxide solid solution containing no additive. In addition, the nickel particles precipitated were highly dispersed on the magnesia solid-solution particles without overlapping.

In Table 1 are shown the results concerning output density obtained by I-V characteristics evaluation. In the table, the Catalyst precursor amount means the proportion of NiO or of MgO—NiO solid-solution particles.

It can be clearly seen from the table that in the conventional Ni-YSZ material, output characteristics are constant regardless of whether the surface layer part has a printed conductive wiring or not. This means that the nickel itself has a firm bonding network and electronic conductivity has been sufficiently secured. The output density decreased with decreasing nickel amount.

In contrast, in the case of the materials according to the Examples, output characteristics tended to improve even with small nickel amounts. This is thought to be attributable to the following. The nickel-magnesium solid solution serving as a nickel-supporting base had almost no electronic conductivity and, hence, the internal resistance of the electrodes could be reduced by adding the solid solution in a reduced amount. In addition, the reduced solid-solution amount resulted in an increased amount of YSZ paths, which conduct oxygen ions. Conversely speaking, the electrodes have sufficiently high catalytic activity even with small nickel amounts. It was further found that the formation of a meshy wiring on a surface layer part by printing was highly effective. Namely, in the techniques according to the Examples, in which (Ni, Mg)O was used as a catalyst precursor, contact with the current collector for current collection was important although catalytic activity improved with decreasing catalyst size. It has become obvious that the formation of a meshy wiring on a surface layer part by printing is highly effective in reducing the loss to be caused by current collection contact resistance.

It can be seen from those results that output characteristics equal to or higher than those of conventional materials can be imparted with smaller catalyst amounts according to this embodiment. This is thought to be mainly caused by an increased amount of three-phase interfaces due to the catalyst particle size reduction and the resultant increase in catalytic activity.

Furthermore, the electrode catalysts of the Examples had not undergone the uniting of nickel particles although slight particle growth was observed. No decrease in output density was also observed. Namely, the results obtained show that the catalysts are more effective also from the standpoint of durability. This is attributable to the fact that these catalysts were synthesized at a higher temperature than the conventional NiO-based materials, and means that the catalysts according to the second embodiment have excellent thermal stability.

Incidentally, YSZ itself has poor electronic conductivity and, hence, use of this material failed to give values far higher than those for Ni-YSZ. However, due to the effects of precipitating finer metal particles and fixing the particles to the base, the fuel electrodes have advantages of having high catalytic activity at high temperatures and being usable stably.

Also in the case of using a cobalt-magnesium composite oxide solid solution as a precursor, almost the same results were ascertained to be obtained when Sc₂O₃, Al₂O₃, or Cr₂O₃ was used as a minor additive.

Furthermore, cells employing the fuel electrodes according to the Examples in combination with various air electrodes were found to show satisfactory output performance. As an air-electrode material, use can be made of, for example, one represented by the general formula Ln₁₋ₓAₓBO_{3-δ} (wherein Ln is a rare-earth element; A is Sr, Ca, or Ba; and B is at least one of Cr, Mn, Fe, Co, and Ni), such as (La, Sr) (Co, Fe)O₃; this material may be disposed over the electrolyte plate through an SDC layer having a thickness of 1 μm as a reaction-inhibitive layer for inhibiting reaction with the electrolyte. At least one member selected from SDC materials, GDC materials, and YDC materials may be added to the Ln₁₋ₓAₓBO_{3-δ} in order to enhance ionic conductivity. A fuel cell system produced from one or more cells employing such a combination was ascertained to have high durability and show high-performance power-generating properties. Such cells can be extensively applied not only to the flat type but also to the cylindrical type and fuel-electrode-supported type.

The magnesium-based composite oxide solid solution which comes to support fine metal particles, which was used in the embodiment described above, is useful also as a catalyst for the reforming of hydrocarbon fuels including methane. This solid solution is hence expected to be applied to techniques concerning SOFCs of the internal reforming type.

Although fuel electrodes for use in solid oxide fuel cells were mainly explained above, the fuel electrodes according to each embodiment can be used also in solid electrolyte high-temperature steam electrolysis cells.

The aluminum-based composite oxide solid solution and/or magnesium-based composite oxide solid solution having fine metal particles supported thereon according to the embodiment of the invention was applied to the fuel electrode (steam electrode) of an electrolytic cell (SOEC) for electrolyzing steam to take out hydrogen. As a result, it was ascertained that the cell efficiently electrolyzed steam to yield hydrogen and that the cell showed characteristics with little metal particle growth and excellent durability.

The nickel-aluminum-based composite oxide sinter particles (19) or nickel-magnesium-based composite oxide particles (19), which are catalyst precursors, take a remarkable effect for making the output density improve, when the specific surface area thereof is set within the range of 5 m²/g or larger and preferably from 10 to 30 m²/g. The larger the specific surface area of the particles, that is, the smaller the particle diameter thereof, the larger the amount of the metal fine particles exposed on the surface thereof after conducting the reduction. Accordingly, because the amount of the effective metal fine particles which can be used as reactive sites is increased, the output density is improved. However, when the specific surface area exceeds 30 m²/g, because the sinter density of a material constituting the fuel electrode is increased and there is a possibility that the dispersion path for water vapor to be formed by a reaction may be curbed, it is necessary to device a countermeasure such as an addition of pore-forming material to the constitution material.

Further, it is likewise preferable that the ionically conductive particles ion to be combined with the above-described composite oxide sinter particles have the specific surface area of 5 m²/g or larger. This is effective in forming a large number of contact sites (reactive sites) with the metal fine particles deposited by conducting the reduction. Further, the above-described ionically conductive particles may be prepared by mixing a plurality of particles having particle sizes different in the specific surface areas with each other and used in order to effectively form an ion conduction path. As described above, the improvement of the catalytic activity by increasing the reactive sites results in the decrease in the overvoltage and as a results the output density is improved.

### Example 13

The nickel-aluminum-based composite oxide sinter particles which were obtained by mixing the NiO powder and the Al₂O₃ powder in a molar ratio of 1:1 and sintering the resulting mixture in Example 1 were further pulverized by means of a planetary ball mill to obtain powders having the specific surface area of 20.0 m²/g. The thus pulverized composite oxide particles and YSZ particles (ZrO₂ stabilized with 8 mol % Y₂O₃) having the specific surface area of 6.0 m²/g were weighed out in such amounts as to result in a weight ratio of 20:80. The powders were mixed together.

Pure water was added to the mixed powders in an amount of about 40% based on the total weight thereof. The resultant mixture was treated with a high-speed rotary mixer to obtain a paste. Using a screen printer, the paste was printed in a size with a diameter of 6 mm on a central part of a YSZ solid electrolyte plate. After the printing, the solid electrolyte plate was placed in an atmospheric furnace and the paste was burned at 1,300° C. for 2 hours. Thereafter, a platinum electrode likewise having a diameter of 6 mm was deposited on the opposite side by screen printing and burned at 950° C. for 1 hour to obtain an air electrode. The same meshy wiring as that shown in Example 1 was formed by printing on a surface layer part of the fuel electrode produced.

### Example 14

The nickel-aluminum-based composite oxide sinter particles used in Example 13 which were pulverized so as to have the specific surface area of 20.0 m²/g and the YSZ particles (ZrO₂ stabilized with 8 mol % Y₂O₃) which were likewise pulverized so as to have the specific surface area of 24.5 m²/g were weighed out in such amounts as to result in a weight ratio of 20:80. The powders were mixed together.

Pure water was added to the mixed powders in an amount of about 40% based on the total weight thereof. The resultant mixture was treated with a high-speed rotary mixer to obtain a paste. Using a screen printer, the paste was printed in a size with a diameter of 6 mm on a central part of a YSZ solid electrolyte plate. After the printing, the solid electrolyte plate was placed in an atmospheric furnace and the paste was burned at 1,300° C. for 2 hours. Thereafter, a platinum electrode likewise having a diameter of 6 mm was deposited on the opposite side by screen printing and burned at 950° C. for 1 hour to obtain an air electrode. The same meshy wiring as that shown in Example 1 was formed by printing on a surface layer part of the fuel electrode produced.

An explanation is made on the results. In Example 13, the output density in the fuel electrode half cell constituted of the mixed phase of the nickel-aluminum-based composite oxide sinter particles (NiAl₂O₄ particles) the specific surface area of which was increased to 20.0 m²/g by the pulverization and the YSZ powders having the specific surface area of 6.0 m²/g was 120 mW/cm². Even when the particle size of the nickel-aluminum-based composite oxide sinter particles is decreased, the size of nickel particles deposited on the surface of the composite oxide sinter particles after conducting the reduction hardly be changed. Accordingly, when the particle size of the nickel-aluminum-based composite oxide sinter particles which are catalyst precursors is reduced, because the contact sites of the metal particles exposed on the surface thereof with the YSZ particles which are the ionically conductive particles are increased, it is possible to make the catalytic activity improve.

In Example 14, the output density in the fuel electrode half cell constituted of the mixed phase of the nickel-aluminum-based composite oxide sinter particles (NiAl₂O₄ particles) the specific surface area of which was increased to 20.0 m²/g by the pulverization and the YSZ powders having the specific surface area of 24.5 m²/g was 124 mW/cm². When the overvoltage due to only the fuel electrode except the overvoltage due to the electrolyte resistance was investigated, the effect of remarkably reducing the overvoltage at the low to medium electrical current density region was taken. On the other hand, the overvoltage was slightly increased at the high electrical current density region. In this region, the overvoltage due to the dispersion condition of the reaction gas was shown. Because the particle sizes of both particles were reduced, the density of the fuel electrode was increased. That is, because the pores are decreased, there is a possibility that the dispersion of gas might be insufficient. Under the circumstances, the increase in the density of the fuel electrode can be controlled by introducing the pore-forming material and the like.

What is claimed is:

1. A fuel electrode for a solid oxide electrochemical cell comprising:
an electrode layer comprising a mixed phase constituted of zirconia stabilized with yttrium oxide, ytterbium oxide, or scandium oxide and of an oxide selected from the group consisting of an aluminum-based oxide and a magnesium-based composite oxide, said oxide having, supported on a surface layer part thereof, particles of at least one member selected from nickel, cobalt, and nickel-cobalt alloys;
a meshy wiring formed on a surface part of the electrode layer and comprising a material having higher electronic conductivity than the electrode layer; and
a current collector which overlies the electrode layer and is in contact with the wiring.

2. The fuel electrode of claim 1, wherein the particles have an average particle diameter of from 5 nm to 200 nm.

3. The fuel electrode of claim 1, wherein the material of the wiring comprises a composite material comprising at least one metal selected from Pt, Au, Ni, Co, and Fe and the stabilized zirconia.

4. A solid oxide electrochemical cell including:
a solid electrolyte plate having oxygen ion conductivity;
a fuel electrode formed on one side of the solid electrolyte plate, the fuel electrode comprising: an electrode layer comprising a mixed phase constituted of zirconia stabilized with yttrium oxide, ytterbium oxide, or scandium oxide and of an oxide selected from the group consisting of an aluminum-based oxide and a magnesium-based composite oxide, said oxide having, supported on a surface layer part thereof, particles of at least one member selected from nickel, cobalt, and nickel-cobalt alloys; a meshy wiring formed on a surface part of the electrode layer and comprising a material having higher electronic conductivity than the electrode layer; and a current collector which overlies the electrode layer and is in contact with the wiring; and
an air electrode formed on the other side of the solid electrolyte plate, the air electrode comprising a composite oxide represented by Ln₁₋ₓAₓBO_{3-δ} (wherein Ln is a rare-earth element; A is Sr, Ca, or Ba; and B is at least one of Cr, Mn, Fe, Co, and Ni) or comprising a composite phase constituted of the composite oxide represented by Ln₁₋ₓAₓBO_{3-δ} and cerium oxides doped with at least one of samarium oxide, gadolinium oxide, and yttrium oxide.

5. The solid oxide electrochemical cell of claim 4, wherein the particles have an average particle diameter of from 5 nm to 200 nm.

6. The solid oxide electrochemical cell of claim 4, wherein the material of the wiring comprises a composite material comprising at least one metal selected from Pt, Au, Ni, Co, and Fe and the stabilized zirconia.

7. A process for producing a fuel electrode for a solid oxide electrochemical cell comprising the steps of:
producing a mixture of zirconia particles stabilized with yttrium oxide, ytterbium oxide, or scandium oxide and nickel-aluminum composite oxide particles, cobalt-aluminum composite oxide particles, or composite oxide particles composed of a nickel-aluminum composite oxide and a cobalt-aluminum composite oxide;
superposing a layer of the mixture on a surface of a solid electrolyte and burning the mixture layer; and
reducing the resultant burned mixture at a temperature of from 800° C. to 1,000° C.

8. The process of claim 7, wherein the stabilized zirconia particles are mixed with the nickel-aluminum composite oxide particles, cobalt-aluminum composite oxide particles, or composite oxide particles composed of a nickel-aluminum composite oxide and a cobalt-aluminum composite oxide, in a ratio of from 50:50 to 90:10 by weight.

9. A process for producing a fuel electrode for a solid oxide electrochemical cell comprising the steps of:
producing a mixture of zirconia particles stabilized with yttrium oxide, ytterbium oxide, or scandium oxide and nickel-magnesium composite oxide particles, cobalt-magnesium composite oxide particles, or composite oxide particles composed of a nickel-magnesium composite oxide and a cobalt-magnesium composite oxide;
superposing a layer of the mixture on a surface of a solid electrolyte and burning the mixture layer; and
reducing the resultant burned mixture at a temperature of from 800° C. to 1,000° C.

10. The process of claim 9, wherein the stabilized zirconia particles are mixed with the nickel-magnesium composite oxide particles, cobalt-magnesium composite oxide particles, or composite oxide particles composed of a nickel-magnesium composite oxide and a cobalt-magnesium composite oxide, in a ratio of from 50:50 to 90:10 by weight.

11. The process of claim 9, wherein the magnesium-based composite oxides each contain at least one of Sc, Al, and Cr, the content of the at least one of Sc, Al, and Cr being from 0.01% by mole to 1.0% by mole based on the magnesium-based composite oxide.
